(19) United States
(12) Patent Application Publication
(10) Pub. No.: US 2019/0164111 A1
(43) Pub. Date: May 30, 2019

(54) SYSTEM FOR COMMUNICATION WITH A REPRESENTATIVE

(71) Applicant: Lester Jason Demello, Bardez (IN)

(72) Inventor: Lester Jason Demello, Bardez (IN)

(21) Appl. No.: 16/321,732

(22) PCT Filed: Jul. 28, 2017
(86) PCT No.: PCT/IN2017/050312

§ 371 Date: Jan. 29, 2019

(30) Foreign Application Priority Data
Jul. 29, 2016 (IN) 201621026031

(51) Int. Cl. G06Q 10/06; G06Q 50/26

(52) U.S. Cl. CPC G06Q 10/063114; G06Q 50/26; G06Q 10/0633; G06Q 10/06316

(57) ABSTRACT

The present disclosure relates to a system for facilitating communication and tracking the status of an individual's query to a representative of an elected representative via a Phone app, email or web based dashboard wherein the individual communicates his query to the representative which is communicated electronically to the intended recipient and the hierarchy of officials who will act upon the query, the official meets the individual in a stipulated time and thereafter periodically the representative communicates with the individual to verify is the query is addressed with various results.

### CROSS-REFERENCE TO RELATED APPLICATIONS AND PRIORITY

The present application claims priority from Indian patent bearing application number 201621026031 filed on 29 Jul. 2016.

### TECHNICAL FIELD

This invention relates to a computer system to facilitate follow up of communication of an individual's query to an elected representative with the intention of resolving the query via the internet, phone or web-based application and more particularly, to a method and apparatus in which the status of the query is tracked by a third party being a representative of the elected representative and the said status is intimated to the hierarchy of the officials in charge from a computer server via the internet.

### BACKGROUND OF THE INVENTION

The current socio-political clime of the country is reaching a point where an invisible bather exists between politicians and the local citizen. The barrier consists of people employed by the politician, the lower ranked members of the political parties, lobbyists, wealthy patrons, etc. The average citizen who has voted for the local MLA or politician, in anticipation of a better city or town, a better environment, a better locale and expedited problem solving is left with no direct recourse to his local party representative. Often times, the public works department, the electricity or water department has to carry out the task of repair which is the cause for concern to the citizen. However, the backlog of complaints with these public utility departments is vast and a local representative of the MLA in power or the political party in question can easily oversee the task and ensure that the complaint or issue is resolved. But because of the barrier of communication between the citizen and the politician, and no adequate means of reminder or method in place which would ensure that the issue resolution is carried out successfully, the citizen is left disgruntled.

Further, the average citizen is approached by the local politician who wishes to win the elections. If the complaints or issues logged by the citizen have been addressed by the political candidate, he (the candidate) has no records currently to prove that the issue was resolved by him. Therefore securing the citizen's vote and goodwill for the next term or for a new term becomes an arduous task.

A citizen hoping to be heard who utilizes the phone or approaches the politician's office directly has no chance of being heard and is often left frustrated and discouraged. This is because other, wealthier patrons funding or contributing to the party or even other party members who are closer to the politician have priority over the politician's time. Therefore visits by the citizen or phone calls result in unanswered calls, busy signals, innumerable hours waiting, etc. An average citizen can never hope to get through the door for a personal visit with the politician. The citizen is often rebuffed by the lower ranking members saying that the politician is “not in” or “in a meeting”, and thus the citizen's concern is never addressed.

Thus there exists a manifold need for a communication channel between the average citizen and a government official or politician, whereby the citizen can login a complaint and the political leader can address such issues and ensure resolution of the same.

### SUMMARY OF THE INVENTION

Before the present system for tracking status of a query from an individual to an elected representative are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application. This summary is provided to introduce aspects related to system for facilitating communication between an individual and elected representative including tracking of work order and the aspects are further described below in the detailed description. This summary is not intended to identify essential features of the claimed subject matter nor is it intended for use in determining or limiting the scope of the claimed subject matter.

Accordingly, the present invention provides a system, including a computer program product, implementing techniques for developing and facilitating and tracking communication to a elected representative through a third party using phone or web-based application.

The system may include a configurable user interface, intelligent workflow management, enhanced navigation, dynamic reporting capabilities, data view and convenient data manipulation. The system provides a platform for facilitating and tracking communication between an individual and a government official and method and software for tracking workflow.

### BRIEF DESCRIPTION OF THE DRAWINGS

The foregoing detailed description of embodiments of system for facilitating and tracking the status of a query or communication between an individual and elected representative including tracking of work order and the aspects is better understood when read in conjunction with the appended drawings. For the purpose of illustrating of the present subject matter, an example of the system involved is provided as figures; however, the invention is not limited to the specific system disclosed in the document and the figures.

In the detailed description, an embodiment of the system for facilitating and tracking status of a query from an individual and elected representative including tracking of work order and the aspects is described in detail with reference to the accompanying figures. In the figures, the left-most digit(s) of a reference number identifies the figure in which the reference number first appears. The same numbers are used throughout the drawings to refer various features of the present subject matter.

FIG. 1 illustrates a flowchart for system for facilitating communication between an individual and elected representative including tracking of work order and the aspects in accordance with an embodiment of the present subject matter.

FIG. 2 illustrates the status of the query from Day 2 to Day 37.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Various modifications to the embodiment will be readily apparent to those skilled in the art and the generic principles herein may be applied to other embodiments for facilitating communication between an individual and an elected representative. However, one of ordinary skill in the art will readily recognize that the disclosure for the present invention is not intended to be limited to the embodiments described, but is to be accorded the widest scope consistent with the principles and features described herein.

The present disclosure relates to a system and an apparatus, including a computer program product, implementing techniques for developing and facilitating and tracking the status of a query to a elected representative through a third party using phone or web-based application. The system may include a configurable user interface, intelligent workflow management, enhanced navigation, dynamic reporting capabilities, data view and convenient data manipulation. The system provides a platform for facilitating and tracking the status of a query or communication between an individual and an elected representative and software for tracking workflow.

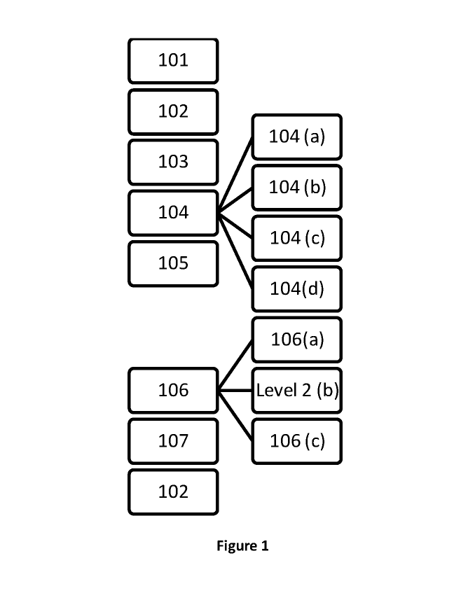

Referring now to FIG. 1, 101 is the system taken up by an elected representative to address a query 103 by an individual 102.
Individual, 102 is the Voter/consumer of services provided by the elected representative
Query, 103 that Individual 102 may have is communicated through A Contact Point 104

Phone app 104(a)

Call Centre/Telephone contact 104(b)

Web Form 104(c)

Office of the elected representative 104(d)
A unique Identifier Number, 105 is generated for this specific query, 103.
This query 103 is communicated direct to the official 106 through the internet vide his contact point 104. The official 106 is pre-determined by the elected representative in the process by area of the individual 102 e.g. by the pin code of the individual 102 or ward number that is pre defined as the specific official 106 service area. The official 106 is predefined as the lowest in the hierarchy chart of the elected representative and for this diagram marked as Level 4, but levels can be created as many as the elected representative needs up to 100
The query 103 is also triggered to Level 3 that is pre-defined as a level above. This is done vide the address levels e.g. Level 3 may be placed in charge of all wards under a specific municipality. All complaints/Issues under this jurisdiction with multiple officials 106 below will display on the LEVEL 3 dashboard/Phone App/and email trail.
The same query 103 will be communicated also to the Higher up level 2 that is pre-defined as a level above. This is done vide the address levels. Eg. Level 2 may be placed in charge of all municipalities in a specific state and will receive notifications for all Level 3 and Level 4 notifications. All queries 103 under this jurisdiction with multiple Level 3 and under their Level 4 officials 106 will display on the LEVEL 2 dashboard/Phone App/and email 104 trail.
The same query 103 will be communicated also to the highest Level i.e. Level 1, which could either be the CEO/Political candidate/elected representative and can also give multiple people this right as Level 1. This is the highest level of the elected representative hierarchy table and is the one that can oversee all of the various queries 103 for the whole service region. All queries under this service area with multiple Level 2 and all of their specific Level 3 and under that their Level 4 official 106 will display on the LEVEL 1 dashboard/Phone App/and email trail.
The official 106 of Level 4 now meets or calls on the individual 102.

In one implementation, the system 101 may be implemented in a cloud-based environment in which the individual 102 may operate individual computing systems 104 configured to execute remotely located applications. In another embodiment, the system 101 may be implemented in the device of the individual 102. It may be understood that the system implemented on the customer device supports a plurality of browsers and all viewports. It will also be understood that the system 101 may be accessed by multiple users of the customer at one or more contact points 104-(a), 104-(b) . . . and 104-(n). Examples of the contact point 104 may include, but are not limited to, such as a laptop computer, a desktop computer, a notebook, a workstation, a main frame computer, a server, a network server, a cloud-based computing environment and the like. The contact points 104 are communicatively coupled to the system 101.

In one embodiment, the system comprises of the individual 102 communicating to the official 106 of the elected representative regarding the query 103. In the same embodiment, the query 103 is intimated to the intended recipient and the hierarchy of officials 106 working under the recipient down to the official 106 who will actually act upon the query 103. 24 hours after the stipulated time i.e. on day 2, a representative communicates with the individual 102 at least once to verify if the query 103 was addressed with the following result:
(i) If the individual 102 communicates that the query 103 is in the process of being addressed by the official 106, the said representative flags the query 103 as “In Progress” and the representative communicates with said individual 102 on Day 9
(ii) If the individual 102 communicates that the said official 106 has not established contact with him, the representative red flags the query as “Not met” and intimates the official 106 and the entire hierarchy above him till the recipient and reestablishes contact with individual 102 on Day 3
(iii) If the individual 102 communicates that the query 103 was successfully addressed, the query 103 is flagged in the representative's database as completed;
(iv) If the individual 102 communicates that it is not possible for the official 106 at this time to address the individual's query 103, the said representative flags the query 103 as “Not Possible”;

In the same embodiment, if the query 103 is flagged as “Not met” on Day 2, the above steps repeat until the query 103 is addressed and the issue resolved or the query 103 is flagged as “not possible”.

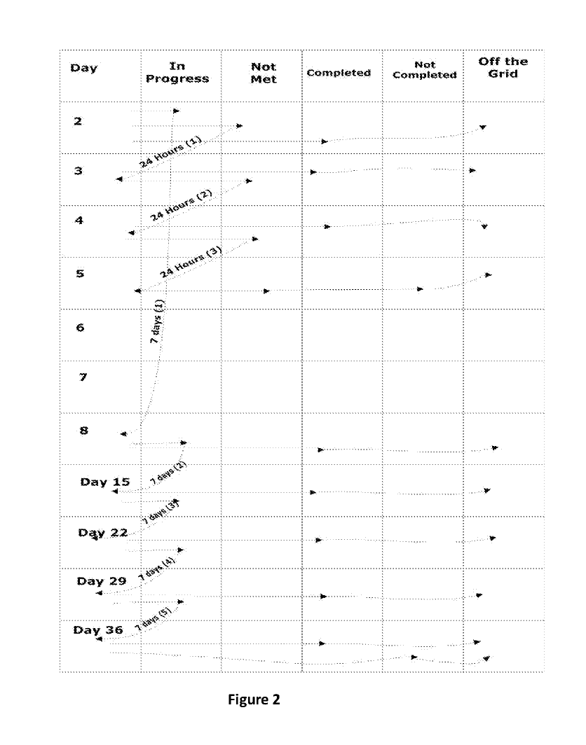

Referring now to FIG. 2, the system could comprise the steps of:
a. Said individual 102 communicates the query 103 to the office of the elected representative;
b. Said query 103 is intimated via multiple contact channels of hardware and/or software 104 to the elected representative and the hierarchy of officials 106 working under the elected representative down to the official 106 who is designated to act upon the query 103;
c. Said official 106 who is to act upon the query 103 meets the said individual within a stipulated time;
d. 24 hours after the stipulated time (Day 2), said representative communicates with the individual 102 at least once to verify if the query 103 was addressed with the following result:
   (i) If the individual 102 communicates that the query 103 is in the process of being addressed by the official 106, the said representative flags the query as “In Progress” and the representative communicates with said individual 102 on Day 9
   (ii) If the individual 102 communicates that the said official 106 has not established contact with him, the representative red flags the query 103 as “Not met” and intimates the official 106 and the entire hierarchy above him till the recipient and reestablishes contact with individual 102 on Day 3
   (iii) If the individual 102 communicates that the concern was successfully addressed, the query 103 is flagged in the representative's database as completed;
   (iv) If the individual 102 communicates that it is not possible for the official 106 at this time to address the individual's concern, the said representative flags the query 103 as “Not Possible”;
e. If the query 103 is flagged as “Not met” on Day 2, the representative communicates with the said individual 102 after another period of 24 hours (Day 3) to enquire as to the status of the query 103 with the following possible results:
   (i) If the individual 102 communicates that the query 103 is in the process of being addressed by the official 106, the said representative flags the query 103 as “In Progress” and the representative communicates with said individual 102 on Day 10
   (ii) If the individual 102 communicates that the said official 106 has not established contact with him, the representative red flags the query 103 as “Not met” and intimates the official 106 and the entire hierarchy above him till the recipient and reestablishes contact with individual 102 on Day 4
   (iii) Query 103 successfully addressed and flagged off in the representative's database as completed
   (iv) Not possible to address the query 103: complaint flagged off as “Not possible” in representative's database
f. In case of Step e(ii) the Representative communicates with the said individual 102 after another period of 24 hours (Day 4) to enquire as to the status of the query 103 with the said individual 102 with the following results:
   (i) If the individual 102 communicates that the query 103 is in the process of being addressed by the official 106, the said representative flags the query 103 as “In Progress” and the representative communicates with said individual 102 on Day 11
   (ii) If the individual 102 communicates that the said official 106 has not established contact with him, the representative red flags the query 103 as “Not met” and intimates the official 106 and the entire hierarchy above him till the recipient and reestablishes contact with individual 102 on Day 5
   (iii) Query 103 successfully addressed and flagged off in the representative's database as completed
   (iv) Not possible to address the query 103: complaint flagged off as “Not possible” in representative's database
g. In case of Step f(ii) the Representative communicates with the said individual 102 after another period of 24 hours (Day 5) to enquire as to the status of the query 103 with the said individual 102 with the following results:
   (i) If the individual 102 communicates that the query 103 is in the process of being addressed by the official 106, the said representative flags the query 103 as “In Progress” and the representative communicates with said individual 102 on Day 12
   (ii) If the individual 102 communicates that the said official 106 has not established contact with him, the representative red flags the query 103 as “Not possible” and intimates the official 106 and the entire hierarchy above him till the recipient
   (iii) Query 103 successfully addressed and flagged off in the representative's database as completed
   (iv) Not possible to address the query 103: complaint flagged off as “Not possible” in representative's database
h. Following up on Day 2, on Day 9 said representative communicates with the individual 102 at least once to verify if the query 103 was addressed with the following result:
   (i) If the individual 102 communicates that the query 103 is in the process of being addressed by the official 106, the said representative flags the query 103 as “In Progress” and the representative communicates with said individual 102 on Day 16
   (ii) If the individual 102 communicates that the query 103 was successfully addressed, the query 103 is flagged in the representative's database as completed;
   (iii) If the individual 102 communicates that it is not possible for the official 106 at this time to address the individual's query 103, the said representative flags the query 103 as “Not Possible”;
i. Following up on Day 3, on Day 10 said representative communicates with the individual 102 at least once to verify if the query 102 was addressed with the following result:
   (i) If the individual 102 communicates that the query 103 is in the process of being addressed by the official 106, the said representative flags the query 103 as “In Progress” and the representative communicates with said individual 103 on Day 17
   (ii) Query 103 successfully addressed and flagged off in the representative's database as completed
   (iii) Not possible to address the query 103: flagged off as “Not possible” in representative's database
j. Following up on Day 4, on Day 11 said representative communicates with the individual 102 at least once to verify if the query 103 was addressed with the following result:
   (i) If the individual 102 communicates that the query 103 is in the process of being addressed by the official 106, the said representative flags the query 103 as “In Progress” and the representative communicates with said individual 102 on Day 18
   (ii) Query 103 successfully addressed and flagged off in the representative's database as completed
   (iii) Not possible to address the query 103: complaint flagged off as “Not possible” in representative's database
k. Following up on Day 5, on Day 12 said representative communicates with the individual 102 at least once to verify if the query 103 was addressed with the following result:
   (i) If the individual 102 communicates that the query 103 is in the process of being addressed by the official 106, the said representative flags the query 106 as “In Progress” and the representative communicates with said individual 102 on Day 19
   (ii) Query 103 successfully addressed and flagged off in the representative's database as completed
   (iii) Not possible to address the query 103: complaint flagged off as “Not possible” in representative's database
l. Following up on Day 9, on Day 16 said representative communicates with the individual 102 at least once to verify if the query 103 was addressed with the following result:
   (i) If the individual 102 communicates that the query 103 is in the process of being addressed by the official 106, the said representative flags the query 103 as “In Progress” and the representative communicates with said individual 102 on Day 23
   (ii) Query 103 successfully addressed and flagged off in the representative's database as completed
   (iii) Not possible to address the query 103: complaint flagged off as “Not possible” in representative's database
m. Following up on Day 16, on Day 23 said representative communicates with the individual 102 at least once to verify if the query 103 was addressed with the following result:
   (i) If the individual 102 communicates that the query 103 is in the process of being addressed by the official 106, the said representative flags the query 103 as “In Progress” and the representative communicates with said individual 102 on Day 30
   (ii) Query 103 successfully addressed and flagged off in the representative's database as completed
   (iii) Not possible to address the query 103: complaint flagged off as “Not possible” in representative's database
n. Following up on Day 23, on Day 30 said representative communicates with the individual 102 at least once to verify if the query 103 was addressed with the following result:
   (i) If the individual 102 communicates that the query 103 is in the process of being addressed by the official 106, the said representative flags the query 103 as “In Progress” and the representative communicates with said individual 102 on Day 37
   (ii) Query 103 successfully addressed and flagged off in the representative's database as completed
   (iii) Not possible to address the query 103: complaint flagged off as “Not possible” in representative's database
o. Following up on Day 30, on Day 37 said representative communicates with the individual 102 at least once to verify if the query 103 was addressed with the following result:
   (i) Query 103 successfully addressed and flagged off in the representative's database as completed
   (ii) Not possible to address the query 103: complaint flagged off as “Not possible” in representative's database

In an alternative embodiment, the query 103 could be against a corporate goods or service provider.

While only one embodiment of the claimed invention is described herein, this does not preclude other heuristics, forms of communications, flag status and entities with whom said individuals can communicate for dispute or issue resolution

1. A system for facilitating communication and tracking a status of an individual's query to a representative of an elected representative of a government/corporate official via a computerized telephone application, email, or web-based dashboard, the system comprising:
a. a query communicated by an individual to the representative of the government/corporate official;
b. a computerized telephone application, email, or web-based dashboard, wherein said query is intimated to an intended recipient and a hierarchy of officials working under the intended recipient down to an official who will actually act upon the query;
c. wherein the official who is to act upon the query meets the individual within a stipulated time; and
d. wherein periodically, after a stipulated time, the representative communicates with the individual at least once to verify if the query was addressed with the at least one of the following results:
(i) if the individual communicates that a concern of the query is in the process of being addressed by the official, the representative flags the query as “In Progress” on the web-based dashboard and the representative communicates with said individual after another stipulated period;
(ii) if the individual communicates that the official has not established contact with the individual, the representative red flags the query on as “Not met” on the web-based dashboard and the status is intimated to the official and an entire hierarchy above the official till the intended recipient and reestablishes contact with individual after the lapse of a stipulated time period;
(iii) if the individual communicates that the concern of the query was successfully addressed, the complaint is flagged as “Completed” on the web-based dashboard and thus reflected as completed and taken off a grid; or
(iv) if the individual communicates that it is not possible for the official at this time to address the individual's concern of the query, the said representative flags the query as “Not Possible” on the web-based dashboard and a task is taken off the grid.

2. The system of claim 1, (d)(i) and 1 (d)(ii), wherein, the representative communicates via phone, e-mail, or a web-based dashboard at regular periods with the individual about the progress of the query until the status of an issue of the query changes to “completed” or “not possible” on the web-based dashboard after a stipulated number of days.
